(19) United States
(12) Patent Application Publication
(10) Pub. No.: US 2007/0082670 A1
(43) Pub. Date: Apr. 12, 2007

(54) Method for migrating a mobile station identity from a mobile identification number to an international mobile station identity

(76) Inventors: Karen Lee Redell, Naperville, IL (US); Douglas H. Rollender, Bridgewater, NJ (US)

Correspondence Address: WILLIAMS, MORGAN & AMERSON, 10333 RICHMOND, SUITE 1100, HOUSTON, TX, 77042, US

(21) Appl. No.: 11/244,868

(22) Filed: Oct. 6, 2005

(51) Int. Cl. H04Q 7/20

(52) U.S. Cl. 455/435.1

(57) ABSTRACT

In one aspect of the instant invention, a method is provided for controlling international roaming in a communications system. The method comprises storing a 15-digit universal identifier in a mobile device in two locations ordinarily used to store a 15-digit MIN-based-IMSI and a 15-digit true IMSI. The universal identifier is comprised of a 10-digit Mobile Identification Number (MIN) and a 5-digit Home Network Identifier (HNI), which is comprised of a 3-digit Mobile Country Code (MCC) and a 2-digit Mobile Network Code (MNC). Generally, the communications system uses the universal identifier to control international roaming. However, the mobile device transmits only the 10-digit MIN in response to the mobile device being within a home network. To form the 15-digit universal identifier, the home network appends its HNI to the received MIN. When the mobile device is outside of its home network, the mobile device transmits the entire 15-digit universal identifier.

### BACKGROUND OF THE INVENTION

1. Field of the Invention

This invention relates generally to telecommunications, and, more particularly, to wireless communications.

2. Description of the Related Art

In the field of wireless telecommunications, such as cellular telephony, a system typically includes a plurality of base stations distributed within an area to be serviced by the system. Various users within the area, fixed or mobile, may then access the system, and, thus, other interconnected telecommunications systems, via one or more of the base stations. Typically, a mobile device maintains communications with the system as the mobile device passes through an area by communicating with one and then another base station, as the user moves. The mobile device may communicate with the closest base station, the base station with the strongest signal, the base station with a capacity sufficient to accept communications, etc.

Many mobile devices are programmed by a service provider with a 10-digit, unique subscription identifier called a Mobile Identification Number (MIN). In particular, service providers in the United States utilize MIN, rather than the International Mobile Subscriber Identity (IMSI). The MIN may be used by the service provider to validate, provide customized service, and bill correctly. However, there are several shortcomings associated with the use of MIN. For example, with the explosion of cellular telephony, the number of unique MINs is in danger of being exhausted. Further, there is no international standard for MIN usage, and thus, international roaming standards do not support MIN. A mobile device using IMSI cannot roam to a cellular system that only employs MIN and mobile device using MIN cannot roam into a cellular system that only employs IMSI because routing based on MIN is not supported.

### SUMMARY OF THE INVENTION

The present invention is directed to overcoming, or at least reducing, the effects of one or more of the problems set forth above.

In one aspect of the instant invention, a method is provided. The method comprises storing a universal identifier in a mobile device; and transmitting the universal identifier to a base station, wherein the universal identifier is usable for international roaming.

In another aspect of the instant invention, a method is provided. The method comprises.

### BRIEF DESCRIPTION OF THE DRAWINGS

The invention may be understood by reference to the following description taken in conjunction with the accompanying drawings, in which like reference numerals identify like elements, and in which:

FIG. 1 is a block diagram of a typical communications system in which the instant invention may be employed;

FIG. 2A is a stylistic representation of an IMSI numbering scheme that employs at least some aspects of the instant invention and may be used in the communications system of FIG. 1;

FIG. 2B is a stylistic representation of the IMSI numbering scheme used in the United States today; and

FIGS. 3-6 are flow diagrams stylistically illustrating messages exchanged between the various components of the communications system of FIG. 1 based on at least some aspects of the instant invention in which a variety of mobile devices may seek to communicate with a variety of service providers.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions may be made to achieve the developers' specific goals, such as compliance with system-related and business-related constraints, which may vary from one implementation to another. Moreover, it will be appreciated that such a development effort might be complex and time-consuming, but may nevertheless be a routine undertaking for those of ordinary skill in the art having the benefit of this disclosure.

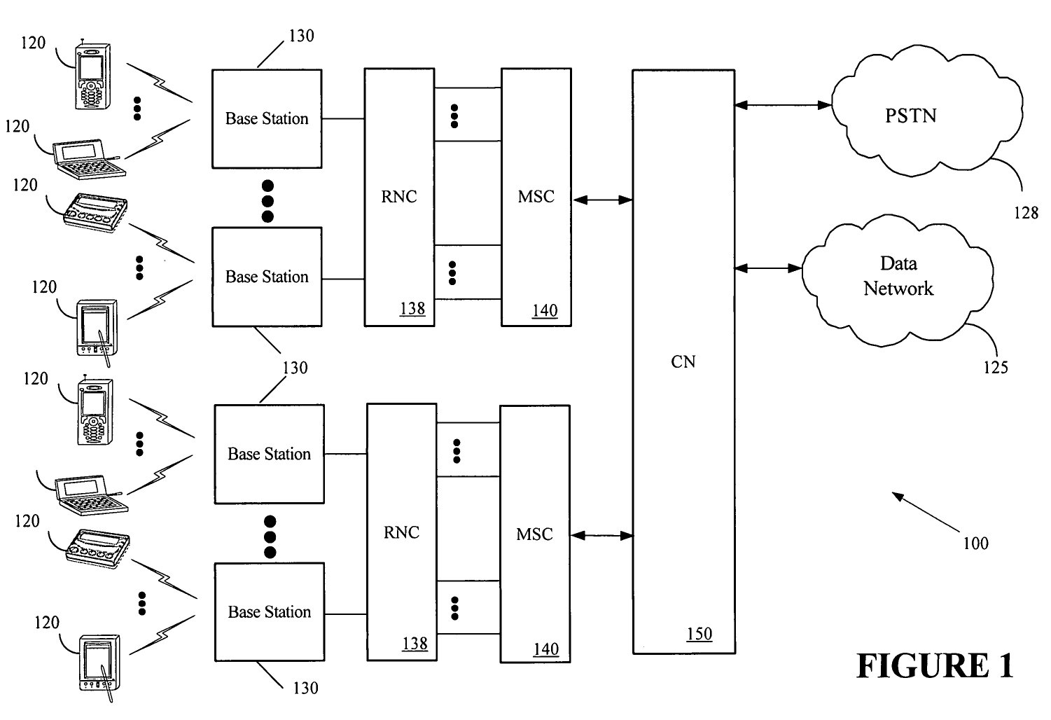

Turning now to the drawings, and specifically referring to FIG. 1, a communications system 100 is illustrated, in accordance with one embodiment of the present invention. For illustrative purposes, the communications system 100 of FIG. 1 is a Code Division Multiple Access (CDMA) system, although it should be understood that the present invention may be applicable to other systems that support data and/or voice communications. The communications system 100 allows one or more mobile devices 120 to communicate with a data network 125, such as the Internet, and/or a Publicly Switched Telephone Network (PSTN) 128 through one or more base stations 130. The mobile device 120 may take the form of any of a variety of devices, including cellular phones, personal digital assistants (PDAs), laptop computers, digital pagers, wireless cards, and any other device capable of accessing the data network 125 and/or the PSTN 128 through the base station 130.

In one embodiment, a plurality of the base stations 130 may be coupled to a Radio Network Controller (RNC) 138 by one or more connections, such as T1 /EI lines or circuits, ATM circuits, cables, optical digital subscriber lines (DSLs), and the like. Those skilled in the art will appreciate that a plurality of RNCs 138 may be utilized to interface with a large number of base stations 130. Generally, the RNC 138 operates to control and coordinate the base stations 130 to which it is connected. The RNC 138 of FIG. 1 generally provides replication, communications, runtime, and system management services. The RNC 138, in the illustrated embodiment handles calling processing functions, such as setting and terminating a call path and is capable of determining a data transmission rate on the forward and/or reverse link for each user 120 and for each sector supported by each of the base stations 130.

Each of the RNCs 138 is coupled to one of a plurality of Mobile Switching Centers (MSCs) 140. The MSCs 140 are generally responsible for providing look-up information regarding call routing for the mobile device 120. Generally, as discussed in greater detail below, the MSC 140 uses the Mobile Station IDentity (MSID) provided by the mobile device 120 to control call routing.

The MSC 140 is also coupled to a Core Network (CN) 150 via a connection, which may take on any of a variety of forms, such as T1/EI lines or circuits, ATM circuits, cables, optical digital subscriber lines (DSLs), and the like. Generally the CN 150 operates as an interface to the data network 125 and/or to the PSTN 128. The CN 150 performs a variety of functions and operations, such as user authentication, however, a detailed description of the structure and operation of the CN 150 is not necessary to an understanding and appreciation of the instant invention. Accordingly, to avoid unnecessarily obfuscating the instant invention, further details of the CN 150 are not presented herein.

The data network 125 may be a packet-switched data network, such as a data network according to the Internet Protocol (IP). One version of IP is described in Request for Comments (RFC) 791, entitled “Internet Protocol,” dated September 1981. Other versions of IP, such as IPv6, or other connectionless, packet-switched standards may also be utilized in further embodiments. A version of IPv6 is described in RFC 2460, entitled “Internet Protocol, Version 6 (IPv6) Specification,” dated December 1998. The data network 125 may also include other types of packet-based data networks in further embodiments. Examples of such other packet-based data networks include Asynchronous Transfer Mode (ATM), Frame Relay networks, and the like.

As utilized herein, a “data network” may refer to one or more communication networks, channels, links, or paths, and systems or devices (such as routers) used to route data over such networks, channels, links, or paths.

Thus, those skilled in the art will appreciate that the communications system 100 facilitates communications between the mobile devices 120 and the data network 125 and/or the PSTN 128. It should be understood, however, that the configuration of the communications system 100 of FIG. 1 is exemplary in nature, and that fewer or additional components may be employed in other embodiments of the communications system 100 without departing from the spirit and scope of the instant invention.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system's memories or registers or other such information storage, transmission or display devices.

Those skilled in the art will appreciate that in the United States, each of the mobile devices 120 has historically used a unique Mobile Station IDentity (MSID) that is comprised of a Mobile Identification Number (MIN). In existing standards, the MIN is 10-digits long. MIN is assigned and administered by a MIN Block Administrator for wireless service providers in North America and an International Roaming MIN Administrator for wireless service providers outside North America. Under existing standards, each mobile device 120 is allowed to be programmed with two identifiers. One identifier is a 15-digit “true IMSI” and the other is a “MIN-based-IMSI” consisting of a 10-digit MIN preceded by a 5-digit “default” network identifier that is not unique and, therefore, can't be used for routing. In one embodiment of the instant invention, each mobile device 120 is programmed with the same number in both the true IMSI and the MIN-based-IMSI field.

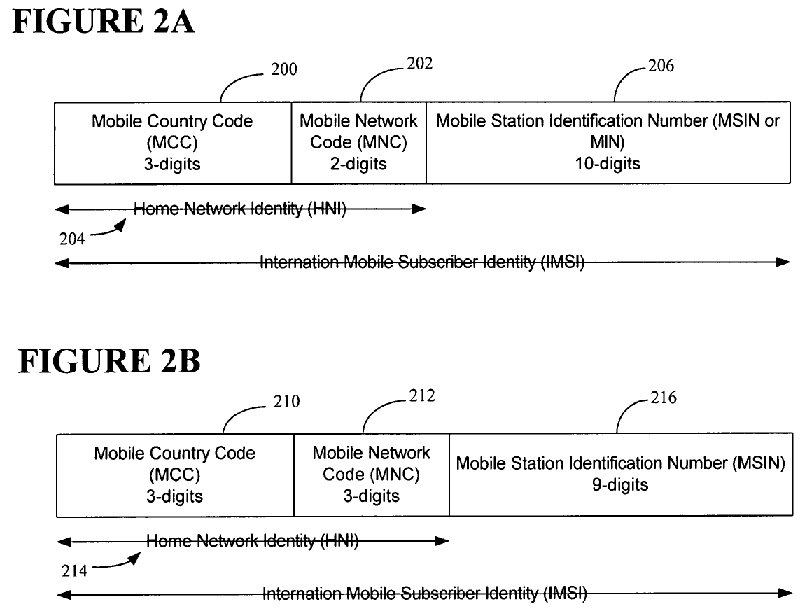

Referring now to FIG. 2A, in one embodiment of the instant invention, the true IMSI and the MIN-based-IMSI are selected to be identical, and each takes the form of a 15-digit number: a 3-digit Mobile Country Code (MCC) 200 and a 2-digit Mobile Network Code (MNC) 202, which together form a 5-digit Home Network Identifier 204. The Mobile Station Identification Number (MSIN) 206 located in the least significant 10-digits of the true IMSI and the MIN-based-IMSI are formed from the conventional 10-digit MIN 206. This scheme for establishing the IMSI differs from current standards for IMSI in North America, as shown in FIG. 2B, in that the current standard for North America does not generally allow for a 5-digit HNI 214, and the HNI 204 in this embodiment of the invention contains information that is assigned and actually identifies the mobile device's home network from the MCC 200 and the MNC 202.

Additionally, the MIN 206 corresponds to and may be used as the MIN for the mobile device 120 when the home network of the mobile device supports the use of MINs 206. It is anticipated that in one embodiment of the instant invention, each service provider will have authority to administer their own MINs. That is, each service provider is allowed to assign MINs 206 without regard to other service providers. Thus, those skilled in the art will appreciate that within the instant invention it is possible for two service providers to assign identical MINs 206 to two different mobile devices 120. However, as discussed in greater detail below, the two mobile devices 120 will have non-identical HNIs 204, yielding a 15-digit IMSI that is unique throughout the world. As the entire 15-digit IMSI is presented by a roaming mobile device 120 when it first attempts to access a serving system, the serving system can use the HNI to identify a roaming subscriber and the roaming subscriber's home service provider.

Those skilled in the art will appreciate that this numbering scheme will alleviate the near-term exhaustion of 10-digit MINs 206 currently facing the industry. Additionally, when a mobile device 120 is within its home network, it may continue to use its 10-digit MIN, rather than is 15-digit IMSI, as the 10-digit MIN 206 is sufficient to uniquely identify each mobile device 120 within its home network.

Some of the beneficial results from this numbering scheme include the fact that existing CDMA operations will support efficient use of the air interface by virtue of its ability to continue using the 10-digit MIN for its subscribers. Additionally, ISPAGE and ISPAGE2 in ANSI-41 can continue to operate properly with only minor modifications since the MIN-based-IMSI and the true IMSI are the same. This means that, in cases where the serving MSC 140 does not have the HNI for a MIN-Based-IMSI to send to a border MSC 140 in the MINExtension parameter within ISPAGE or ISPAGE2, and the border MSC does not support True IMSI (IMSI_T_SUPPORTED=0 in the ESPM described below), then either the serving MSC 140 or the border MSC 140 may assume the HNI is the same as the HNI in the IMSI parameter (True IMSI) and populate the HNI digits in the page.

Further, international roaming is supported without the additional IMSI administration, assignment, and provisioning required for using two kinds of IMSI, the MIN-based-IMSI and the true IMSI. Both kinds of IMSI may now use the same HNI rather than requiring separate HNI assignments. Moreover, the numbering scheme is consistent with current E.214 GTT implementations that support a 5-digit HNI.

Further, since the proposed numbering scheme eliminates the use of 6-digit HNIs, modifications to enhanced Preferred Roaming List (ePRL) is not required. Use of the ePRL requires (a) the base station to broadcast a 5-digit HNI for the potential serving system to identify itself and (b) the mobile device 120 to use this 5-digit HNI to select a serving system to access by comparing it to a priority listing of 5-digit HNIs for preferred roaming partners programmed into the mobile device 120. The 5-digit HNI is broadcast over the air by the base station 130 inside an Extended System Parameter Message (ESPM). With a 5-digit HNI inside the ESPM, mobile ePRLs with 5-digit HNIs do not need to be reprogrammed. Likewise, modifications to IS-2000 to support 6-digit HNIs and modifications IS-683 to provision mobiles over-the-air with a modified ePRL are not required.

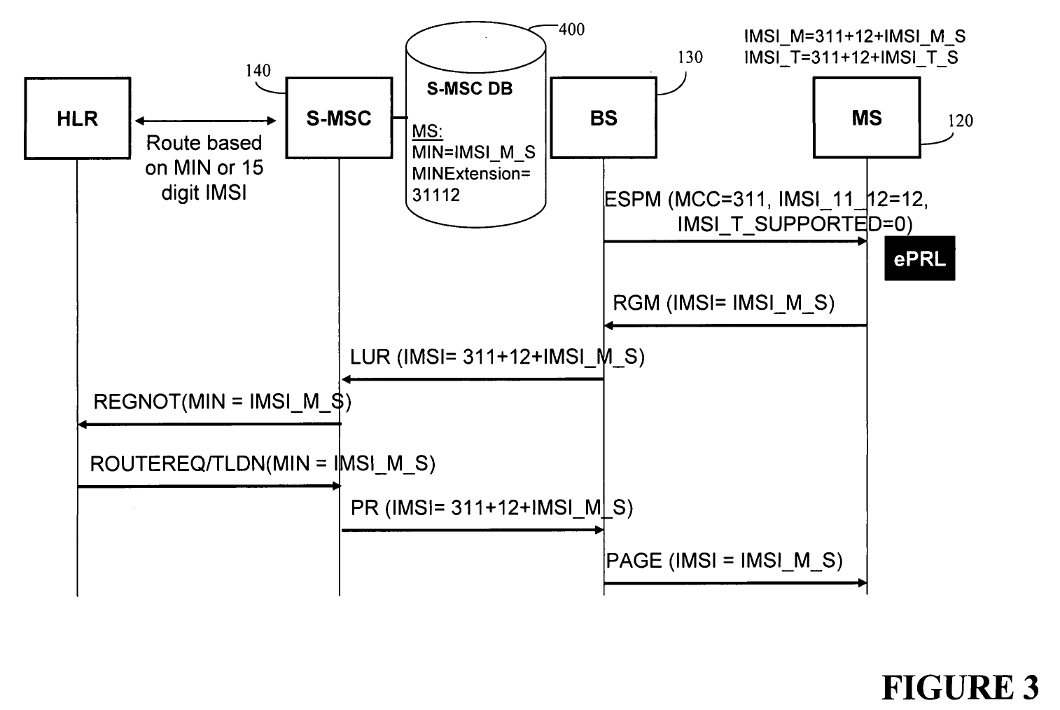

Referring now to FIGS. 3-6, flow diagrams stylistically illustrate messages exchanged between the various components of the system 100 in a variety of scenarios in which a variety of mobile devices 120 may seek to communicate with a variety of service providers.

Referring first to FIG. 3, a mobile device (MS) 120 that has true IMSI and MIN-based-IMSI is attempting to communicate with a base station (BS) 130 of its home service provider, as indicated by its Extended System Parameter Message (ESPM) signaling, which has HNI set to 31112. The base station 130 is also signaling in the ESPM that a 15-digit IMSI is not supported in the mobile application protocol by the serving MSC 140 (IMSI_T_SUPPORTED=0). In this scenario, the mobile device 120 recognizes that it is communicating with its home service provider because the received HNI matches its internally stored HNI, and thus, the mobile device 120 delivers a registration message that contains only the 10-digit MIN portion of its IMSI (RGM (IMSI=IMSI_M_S)). Those skilled in the art will appreciate that under the current standard, the mobile device 120 would always sends a less efficient 15-digit response that would include a 5-digit HNI value of MCC+00 (e.g. 31000 in the US ). This is a default or non-assigned HNI value which is available for use by all service providers in a country in their subscriber's mobile devices. As such, MCC+00 does not uniquely identify a service provider and would not be used in an ePRL, an HNI in the ESPM, or for message routing. Thus, the HNI broadcast in the ESPM would never match the HNI of the IMSI_M in the mobile device 120 and the mobile device 120 would always send 15 digits to the base state 130.

Referring still to FIG. 3, the base station 130 prepends its 5-digit HNI (31112 in this example) and forwards a 15-digit IMSI in a Location Updating Request (LUR) to the serving MSC 140. Because the serving MSC 140 in this scenario does not support a 15 digit IMSI for mobile identification in the mobile application protocol, it stores the HNI portion of the IMSI as a MINExtension in its database 400. The MINExtension is needed for subsequent call delivery. The serving MSC 140 then forwards a Registration Notification (REGNOT) with the MIN portion of the IMSI to a Home Location Register (HLR) located within the network or system 100. The Registration Notification message is routed to the HLR through the network using either the MIN or 15 digit IMSI for intra-system signaling. Those skilled in the art will appreciate that under the current standard a 15-digit unique identifier is not available for routing purposes.

When a call for the mobile device 120 arrives from the network 100 to the serving MSC 140 in the form of ROUTERREQ/TLDN(MIN=IMSI_M_S), the serving MSC 140 forms a 15-digit IMSI Paging Request (PR) by prepending the mobile's previously stored 5-digit HNI stored in the serving MSC database 400 as a MINExtension to the MIN (IMSI_M_S), which is forwarded to the base station 130. The base station 130 then issues a page to the mobile station 120 using only the 10-digit IMSI_M_S, again leading to a more efficient use of the air interface than if a 15-digit IMSI were used for the page.

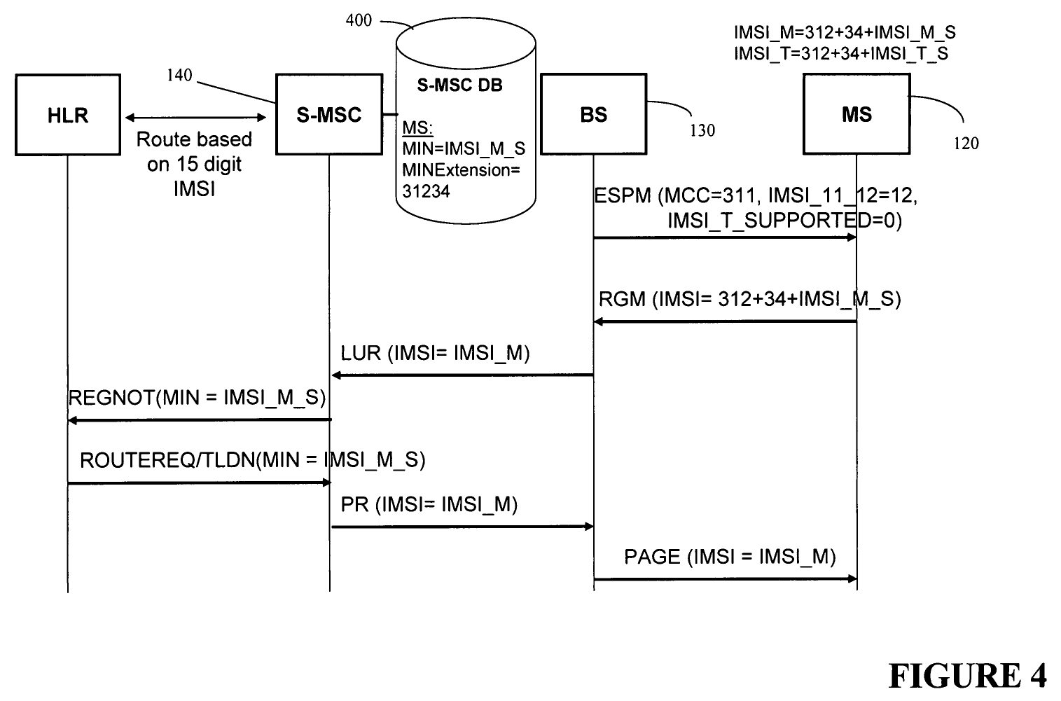

Referring now to FIG. 4, a roaming mobile device (MS) 120 that has true IMSI and MIN-based-IMSI set to identical values with an HNI value of 31234 is attempting to communicate with a base station (BS) 130 of a non-home service provider, as indicated by its ESPM signaling, which has HNI set to 31112 (the HNI for the mobile device 120 is set to 31234). The non-home service provider base station 130 is also signaling in the ESPM that true IMSI is not supported (IMSI_T_SUPPORTED=0) in the mobile application protocol by the serving MSC. The mobile device 120 sends a 15-digit registration message to the base station 130 formed from the MIN-based IMSI (IMSI_M). The base station 130 delivers a 15-digit location updating request based on the same MIN-based-IMSI (LUR(IMSI=IMSI_M)). Again, because the serving MSC 140 does not support a 15 digit IMSI for mobile identification in the mobile application protocol, it stores the HNI portion of the IMSI as a MINExtension in the serving MSC database 400 for subsequent call delivery and then forwards a registration notification to a Home Location Register (HLR) located within the roamer's home network or system 100. The Registration Notification message is routed to the HLR through the network using the 15-digit IMSI presented to the serving MSC by the base station for inter-system signaling. Those skilled in the art will appreciate that under the current standard a 15-digit unique identifier would not be available for routing purposes.

When a call for the mobile arrives from the network 100 to the serving MSC 140 in the form of ROUTERREQ/TLDN(MIN=IMSI_M_S), the serving MSC 140 forms a 15-digit IMSI Paging Request (PR) by pre-pending the previously stored mobile's 5-digit HNI stored in the serving MSC database 400 as a MINExtension to the MIN, which is forwarded to the base station 130. The base station 130 then issues a page to the mobile station 120 using the 15-digit IMSI_M.

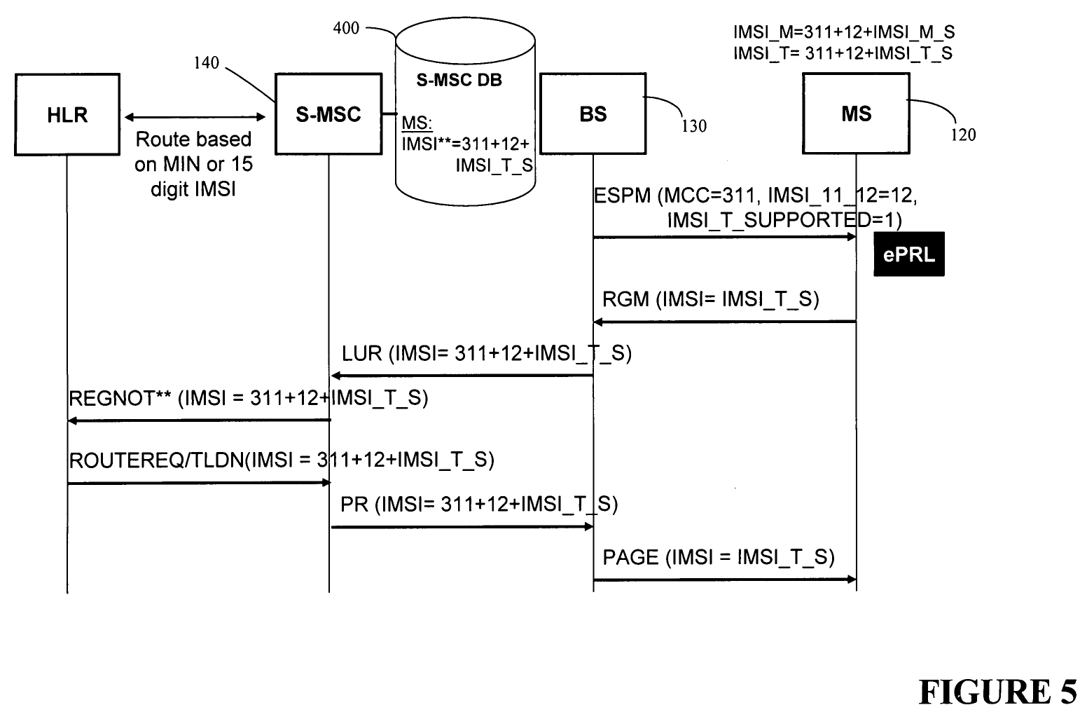

Referring now to FIG. 5, the mobile device (MS) 120 has true IMSI provisioned, which is identical to its MIN-based-IMSI. The ESPM broadcast from the base station 130 includes IMSI_T_SUPPORTED=1. This means the mobile device 120 is attempting to register at the serving MSC 140 using true IMSI_T rather than MIN-based-IMSI. Since the mobile device 120 is at home, as indicated by the fact that the HNI in the ESPM is the same as the HNI in the mobile device 120, the mobile device 120 only needs to send a 10-digit registration message to the base station 130. This is the MIN portion of the true IMSI (IMSI_T_S).

The base station 130 delivers a 15-digit LUR to the serving MSC 140 by pre-pending its HNI onto the same IMSI_T_S portion of the true IMSI (LUR(IMSI=311+12+IMSI_T_S)).

In one embodiment of the instant invention, the MIN Escape Code list in the serving MSC database 400, as described in current standards, is not needed because the mobile is provisioned with both the MIN-based-IMSI and the true IMSI, and the IMSI_T_SUPPORTED value broadcast by the base station 130 in the ESPM indicates whether a MIN or IMSI is supported in the mobile application protocol.

Under the current standard, the serving MSC 140 that supports IMSI in the mobile application protocol must distinguish between a MIN-based-IMSI and a true IMSI received from the mobile device 120. In one embodiment of the instant invention, this is no longer needed because MIN-based-IMSI is equal to true IMSI. Under the current standard, a list, referred to here as a MIN Escape Code list, is stored in the serving MSC 140 for identifying MIN-Based IMSI. This list would at a minimum contain MCCs. These MCCs appended with a 00 would form an HNI identifying an IMSI as a MIN-Based IMSI. The identification of MIN-Based IMSI versus True IMSI was required at the serving MSC 140 because the mobile device 120 does not indicate whether it used the MIN-based-IMSI or true IMSI to register the mobile and MIN-based-IMSI is not equal to true IMSI. Thus, the serving MSC 140 had to identify whether the IMSI received from the mobile device 120 was the MIN-based-IMSI or the true IMSI. Identification of the IMSI was necessary because the serving MSC 140 that supports true IMSI (ESPM(IMSI_T_SUPPORTED=1)) is provided a MIN-based-IMSI when the true IMSI is not provisioned in the mobile device 120. As MIN-based-IMSI and true IMSI are equal in one embodiment of the instant invention, the MIN Escape Code list may no longer be needed.

Since the serving MSC 140 supports true IMSI (IMSI_T_SUPPORTED=1), the serving MSC 140 forwards a 15-digit registration notification to a Home Location Register (HLR) located within the network or system 100 (REGNOT(IMSI=311+12+IMSI_T_S)) using either MIN or IMSI as the network address for the HLR. The network addressing between the serving MSC 140 and the network 100 can be based on either MIN because the MIN is unique within the home network.

When a call for the mobile arrives from the network to the serving MSC 140 in the form of ROUTERREQ/TLDN(IMSI=311+12+IMSI_T_S), the serving MSC 140 sends a 15-digit Paging Request (PR) to the base station 130 using the IMSI received in the ROUTEREQ. The base station 130 then issues a 10-digit page to the mobile station 120 using only the 10-digit IMSI_T_S.

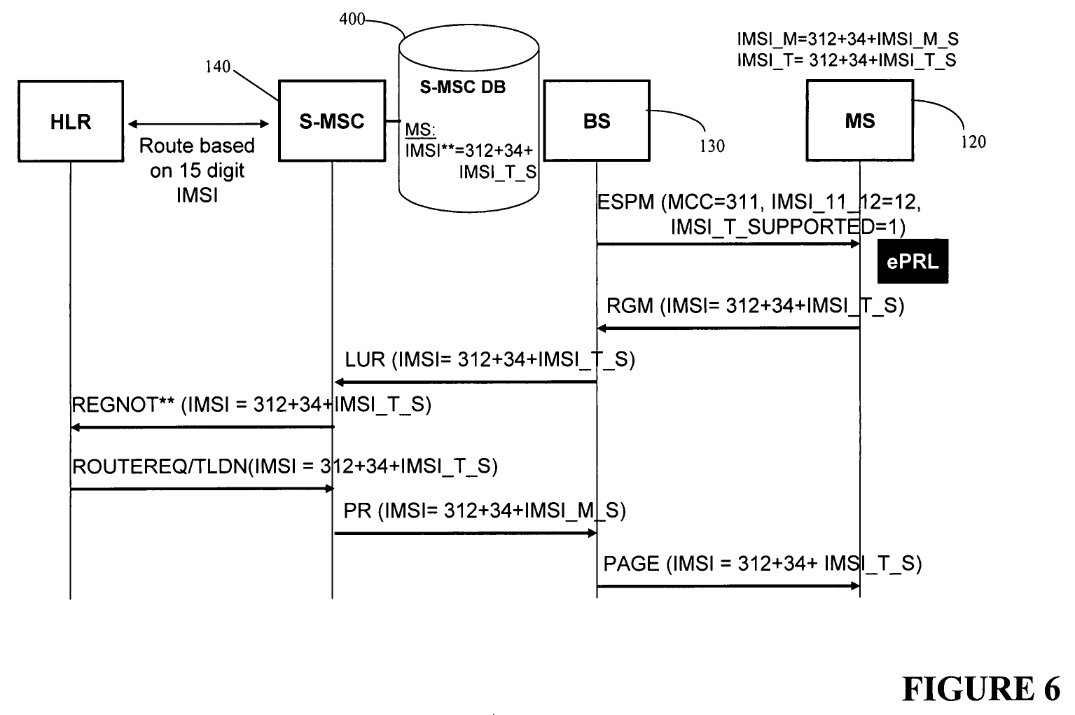

Referring now to FIG. 6, a roaming mobile device (MS) 120 that has true IMSI and MIN-based-IMSI set to identical values is attempting to communicate with a base station (BS) 130 of a non-home service provider, as indicated by its ESPM signaling, which has HNI set to 31112 (the HNI for the mobile device 120 is set to 31234). The non-home service provider base station 130 is also signaling that true IMSI is supported in the mobile application protocol by the serving MSC (IMSI_T_SUPPORTED=1). The mobile device 120 sends a 15-digit registration message to the base station 130 in the form of a true IMSI consisting of an HNI and IMSI_T_S. The base station 130 delivers a 15-digit location updating request based on the same true IMSI (LUR(IMSI=312+34+IMSI_T_S)) to the serving MSC 140. Using a 15-digit IMSI, the serving MSC 140 then forwards a registration notification to a Home Location Register (HLR) located within the network or system 100. The network addressing between the serving MSC 140 and the network is based on IMSI, as MIN is no longer administered to be unique.

For a call for the mobile from the network to the serving MSC 140 in the form of ROUTERREQ/TLDN(IMSI=312+34+IMSI_T_S), the serving MSC 140 forms a 15-digit paging request using the IMSI received in the ROUTEREQ. This is forwarded to the base station 130. The base station 130 then issues a page to the mobile station 120 using the 15-digit IMSI formed from the HNI and IMSI_T_S.

Those skilled in the art will appreciate that the various system layers, routines, or modules illustrated in the various embodiments herein may be executable control units. The control units may include a microprocessor, a microcontroller, a digital signal processor, a processor card (including one or more microprocessors or controllers), or other control or computing devices. The storage devices referred to in this discussion may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions when executed by the control units cause the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. Consequently, the method, system and portions thereof and of the described method and system may be implemented in different locations, such as the wireless unit, the base station, a base station controller and/or mobile switching center. Moreover, processing circuitry required to implement and use the described system may be implemented in application specific integrated circuits, software-driven processing circuitry, firmware, programmable logic devices, hardware, discrete components or arrangements of the above components as would be understood by one of ordinary skill in the art with the benefit of this disclosure. It is therefore evident that the particular embodiments disclosed above may be altered or modified and all such variations are considered within the scope and spirit of the invention. Accordingly, the protection sought herein is as set forth in the claims below.

We claim:

1. A method, comprising:
storing a universal identifier in a mobile device; and
transmitting the universal identifier to a base station, wherein the universal identifier is usable for international roaming.

2. A method, as set forth in claim 1, wherein storing the universal identifier in the mobile device further comprises storing the universal identifier in a first location designated for a MIN-based-IMSI and in a second location designated for a true IMSI.

3. A method, as set forth in claim 1, wherein storing the universal identifier in the mobile device further comprises storing an international mobile subscriber identity comprised of a mobile identification number and a home network identifier where the home network identifier corresponds to a particular service provider.

4. A method, as set forth in claim 3, wherein transmitting the universal identifier to a base station, wherein the universal identifier is usable for universal roaming further comprises transmitting only the mobile identification number in response to the mobile device being within a home network.

5. A method, as set forth in claim 4, wherein transmitting only the mobile identification number in response to the mobile device being within a home network, further comprises:
receiving an indication of the home network identifier of the base station; and
transmitting only the mobile identification number in response to a match between the mobile identification numbers of the mobile device and the base station.

6. A method, as set forth in claim 3, wherein storing the international mobile subscriber identity comprised of the mobile identification number and the home network identifier further comprises storing the international mobile subscriber identity comprised of the mobile identification number and the home network identifier comprised of a country code and a service provider code.

7. A method, as set forth in claim 6, wherein storing the international mobile subscriber identity comprised of the mobile identification number and the home network identifier comprised of a country code and a service provider code further comprises the mobile identification number comprising a 10-digit mobile identification number, the country code comprising a 3-digit country code and the service provider code comprising a 2-digit service provider code.

8. A method, as set forth in claim 3, wherein transmitting the universal identifier to the base station further comprises transmitting the mobile identification number and the home network identifier in response to the mobile device being outside the home network.

9. A method, as set forth in claim 8, wherein transmitting the mobile identification number and the home network identifier in response to the mobile device being outside the home network further comprises:
receiving an indication of the home network identifier of the base station; and
transmitting both the mobile identification number and the home network identifier in response to the mobile identification numbers of the mobile device and the base station being different.

10. A method, comprising:
receiving a universal identifier from a mobile device; and
using the universal identifier to facilitate international roaming.

11. A method, as set forth in claim 10, wherein receiving the universal identifier further comprises receiving an international mobile subscriber identity comprised of a mobile identification number and a home network identifier.

12. A method, as set forth in claim 11, wherein receiving the international mobile subscriber identity comprised of the mobile identification number and the home network identifier further comprises receiving the international mobile subscriber identity comprised of a mobile identification number, a country code, and a service provider code.

13. A method, as set forth in claim 12, wherein receiving the international mobile subscriber identity comprised of a mobile identification number, a country code, and a service provider code further comprises receiving the international mobile subscriber identity comprised of a 10-digit mobile identification number a 3-digit country code and a 2-digit service provider.

14. A method, as set forth in claim 11, further comprising paging the mobile device using only the mobile identification number in response to the mobile device being in a home network.

15. A method, as set forth in claim 14, wherein paging the mobile device using only the mobile identification number in response to the mobile device being in a home network further comprises the base station determining that the mobile device is in the home network by comparing the home network identifiers of the mobile device and the base station.

16. A method, as set forth in claim 11, further comprising paging the mobile device using the international mobile subscriber identity in response to the mobile device being outside of a home network.

17. A method, as set forth in claim 16, wherein paging the mobile device using the international mobile subscriber identity in response to the mobile device being outside of a home network further comprises the base station determining that the mobile device is outside the home network by comparing the home network identifiers of the mobile device and the base station.

18. A method, as set forth in claim 11, wherein receiving an international mobile subscriber identity comprised of a mobile identification number and a home network identifier further comprises receiving only the mobile identification number from the mobile device in response to the mobile device being with a home network, and wherein the home network appends its home network identifier to the mobile identification number to form the international mobile subscriber identity.

19. A method, as set forth in claim 11, wherein receiving an international mobile subscriber identity comprised of a mobile identification number and a home network identifier further comprises receiving both the mobile identification number and the home network identifier from the mobile device in response to the mobile device being outside of a home network.
